(19) United States
(12) Patent Application Publication
(10) Pub. No.: US 2025/0090987 A1
(43) Pub. Date: Mar. 20, 2025

(54) AIR SENSOR TUBE DESIGN FOR IMPROVED MEASUREMENT ACCURACY AND REDUCTION OF DUST RELATED DEGRADATION

(71) Applicant: WOOSH AIR INC., San Francisco, CA (US)

(72) Inventors: William Mark Dodd, San Francisco, CA (US); Mark Lowe, San Francisco, CA (US); Winston Mok, San Francisco, CA (US)

(21) Appl. No.: 18/816,952

(22) Filed: Aug. 27, 2024

Related U.S. Application Data
(60) Provisional application No. 63/539,560, filed on Sep. 20, 2023.

(51) Int. Cl. B01D 46/44; B01D 46/00; B01D 46/10; G01L 13/06; G01L 19/06; G01L 19/14

(52) U.S. Cl. CPC B01D 46/446; B01D 46/0005; B01D 46/10; G01L 13/06; G01L 19/0636; G01L 19/147; B01D 2279/50

(57) ABSTRACT

Embodiments of the present disclosure help to increase the reliability of differential static pressure sensor readings used to remotely monitor the performance of an HVAC air filter. Embodiments of the present disclosure solve two problems, one related to degraded reliability of a differential pressure sensor and the second due to airflow properties such as turbulence impacting the accuracy and repeatability of differential pressure readings. Sensor reliability and lifetime are improved by reducing the access to and accumulation of dust at the sensor element by design of the air column to the sensor. The loss of accuracy and repeatability of sensor readings produced by properties of the airflow such as turbulence, among others, is reduced by a design and placement of a manifold that extends into the incoming air flow from the filter frame.

### PRIORITY CLAIM

The present application claims the benefit of and priority to U.S. Provisional Ser. No. 63/539,560 filed Sep. 20, 2023. The contents of that application are hereby incorporated by reference in their entirety.

### BACKGROUND

Air filtration solutions incorporated into HVAC systems now benefit from increasingly affordable, accurate and diverse sensors. Additionally, HVAC systems are among those increasingly likely to benefit from IoT connectivity. The value added by sensors that track pressure, humidity and other quantities is increased by making it available to handheld devices as well as computing systems over wireless connectivity.

Maximum leverage of sensor data depends on the accuracy of the measurements. Prior art has allowed manufacturers and engineering firms to provide homeowners and facility managers with enhanced control over and insight into their HVAC systems using the sensed data. Nevertheless, there are phenomena that still limit the accuracy of measurements provided by critical sensors tracking differential pressure across an air filter. These sensors are used to gauge the health of the HVAC system. What is required is a solution to problems such as dust-related reduction in reliability and associated inaccuracy in data from pressure sensors as well as detrimental effects, such as non-repeatability of the measurements arising from airflow properties such as turbulence.

### SUMMARY

The current application helps to increase the reliability of differential static pressure sensor readings used to remotely monitor the performance of an HVAC air filter. Embodiments of the present disclosure solve two problems, one related to degraded reliability of a differential pressure sensor and the second due to airflow properties such as turbulence impacting the accuracy and repeatability of differential pressure readings.

Sensor reliability and lifetime are improved by reducing the access to and accumulation of dust at the sensor element by design of the air column to the sensor.

The loss of accuracy and repeatability of sensor readings produced by properties of the airflow such as turbulence, among others, is reduced by a design and placement of a manifold that extends into the incoming air flow from the filter frame.

This invention addresses two problems affecting the operating accuracy and life of air filters for HVAC systems. By monitoring the pressure difference across an air filter, it is possible to track the build-up of dust and to notify a user when the filter needs to be replaced. Dust and other contaminants carried by the unfiltered air can interfere with a differential pressure sensor's operation. Furthermore, turbulent flow and/or other factors can lead to unreliable and non-repeatable differential pressure measurements from the differential pressure sensor.

These two issues are solved by focusing on the design and the placement of the air conduit connecting the space on the high pressure side of the filter to the sensor element. A manifold design that forces dust particles to follow a serpentine path to reach the sensor element may be used, where the differential pressure sensor does not require any flow of air (no-flow through sensor—NFTS). Hence, dust particles are not carried to the sensor element by air flow. This embodiment is not meant to be limiting as other embodiments requiring airflow through the sensor (flow-through sensor, or FTS) and using a serpentine path are covered by the present disclosure. For NFTS, dust particles reach the sensor element by following, for example, a jagged diffusive trajectory involving multiple collisions with the interior of the manifold. Use of the manifold with serpentine air path in NFTS ensures that very few dust particles reach the active elements within the sensor to cause degradation of accuracy.

The problem of unreliability and non-repeatability of sensor readings associated with air flow effects is addressed by designing in geometrical features and a manifold, each contributing to improved signal accuracy.

A capped hollow tube with holes placed around its periphery at optimized distance from the capped probe tip forms a pressure sensing input probe. This probe is placed in the incoming air flow to allow the sensing of the incoming air pressure.

The manifold with the air sensor is placed on the central rib of the frame, sufficiently away from the frame edges to reduce edge related air flow effects. The probe coming out of the manifold into the incoming air flow also has a clearance designed around it on the frame rib of the filter to further improve the consistency of pressure measurement.

The probe design and serpentine path to the high pressure chamber of the differential pressure sensor and the optimized geometric design and placement of the probe/manifold result in improved sensor life and consistent and reliable differential pressure measurement.

### Reference Terms & Acronyms

Pressure sensor: a component used for measuring either absolute pressures or pressure differences. One among many choices of environmental sensors incorporated into an HVAC system. Includes a sensor element which is responsible for generating a measurable electrical signal subsequently relayed by the overall sensor to the microprocessor in the electronics module. In some embodiments, air flow through the sensor chambers is not needed. The term No-Flow-Through Sensor (NFTS) describes this type of pressure sensor. In contrast, a Flow Through Sensor (FTS) requires that some amount of airflow pass through the pressure sensor.

Manifold: responsible for establishing a conduit or air column between the pressure sensor and the air external to the filter, frame and smart module. Described elsewhere as a conduit structure. The air column within the manifold provides fluid communication required for the pressure measurements. It may be made of simple plastic tubing or by injection molding. Includes the probe and one or more ports.

Air Column: defined by the cavity within the manifold. Serves as a conduit between unfiltered air external to the frame and filter at one end of the manifold, and the pressure sensor at the other end.

Ports: openings or holes allowing air to flow into or out of the manifold at the extremity which extends into the unfiltered, flowing air.

Probe: stem or portion of the manifold protruding from the filter frame and into the flow of unfiltered air. The probe passes through the filter fabric and frame and possibly other layers to reach the airflow external to the filter frame. In some embodiments, the probe includes lateral ports or holes in the stem and a capped top. The design of the probe with side ports is helpful to achieve accurate readings from the pressure sensor by reducing or eliminating the dynamic pressure component, and aids in dust rejection by reducing the likelihood of dust entering the probe directly from the airstream.

Serpentine path: The air column within the disclosed manifold, having fluid communication through ports with air external to the manifold. Dust particles reach the sensor by passing through a port, along the air column. This air column contains curves and branching points, reducing the likelihood that a dust particle at a port will reach the sensor element within the pressure sensor.

Clearance hole: an opening in the frame through which the probe emerges into the unfiltered air stream. A clearance around the probe has an impact on the accuracy of the pressure sensor by reducing turbulence or other air flow effects around the intake holes.

### Advantages of the Improved Air Sensor Tube and Manifold Design:

Advantages of embodiments of the present disclosure include but are not limited to:
1. Enhanced lifetime for pressure sensors: air approaching the filter moves at a considerable speed and carries dust particles. These dust particles can cause sensor degradation when colliding with surfaces, and when forming layers of accumulated dust that then coats the sensor or clogs the airflow passage in a FTS. Embodiments of the present disclosure may all but suppress the arrival of dust particles at the pressure sensor, thus enhancing its lifetime.
2. Improved accuracy of pressure sensor data through reduced contamination of sensor element—this invention can minimize or even eliminate this problem by preventing contamination of the sensor element, thus providing a more accurate pressure reading. As a consequence, more reliable feedback is provided to a user or customer regarding the condition of their filter elements and the need to replace them.
3. Improved accuracy of pressure sensor data through optimum placement and clearance between mating parts—the location of the entry port(s) with respect to the front face of the frame and filter (sides of the clearance hole) are optimized to provide more accurate differential pressure measurements between the front and back side of the filter.

### DRAWINGS REFERENCE NUMBERS

The disclosure, and its advantages and drawings, will be better understood from the following description of representative embodiments together with reference to the accompanying drawings. The drawings depict only representative embodiments, and are therefore not to be considered as limitations on the scope of the various embodiments or claims. The following are brief descriptions of corresponding reference numbers in the Figures.

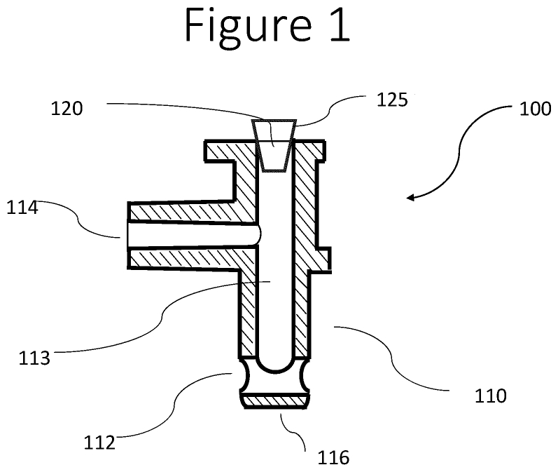

FIG. 1—Manifold and parts
100 Manifold
110 Probe
112 Port
113 Air Column
114 Aperture for connection to sensor
116 Capped extremity of probe
120 Aperture for mounting manifold within (for example) filter frame
125 Plug

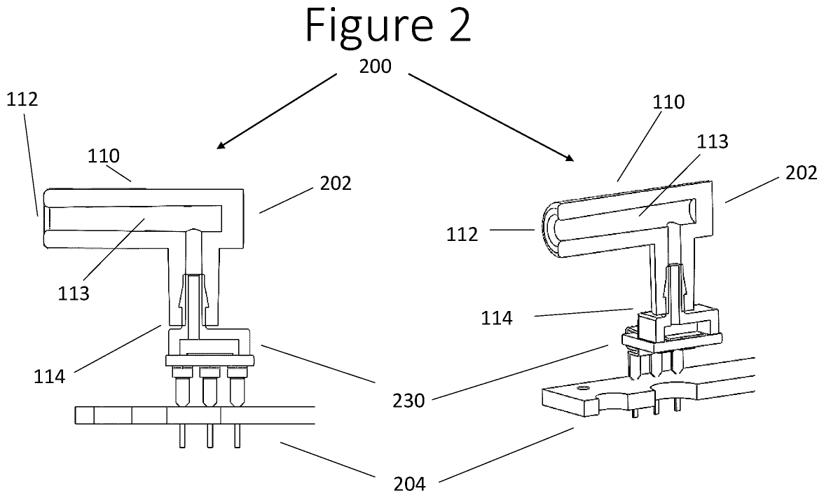

FIG. 2—alternate embodiments of manifold
200 alternate embodiments of manifold
202 Manifold
204 PCB to which sensor is mounted within filter frame
230 sensor for one example of invention implementation

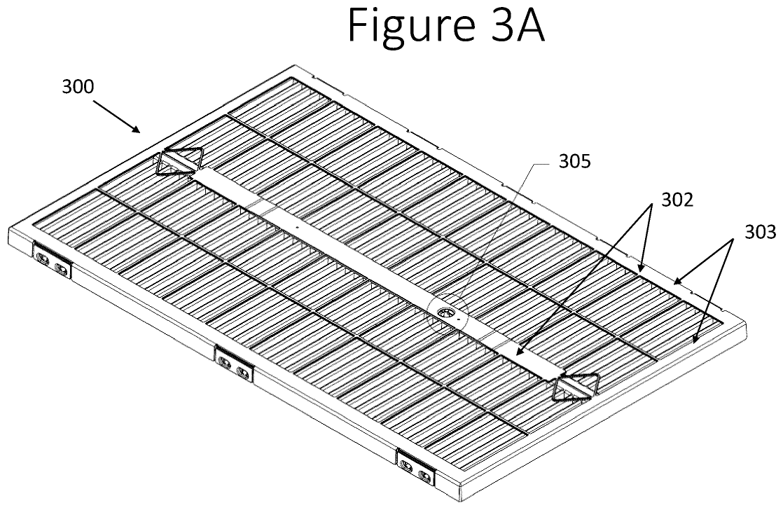

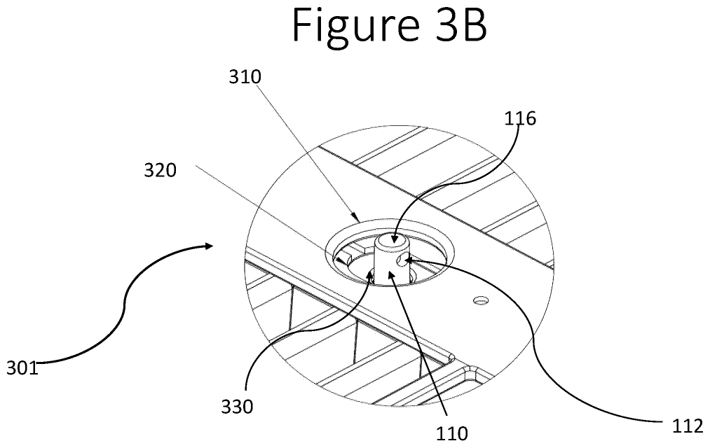

FIG. 3A-frame showing position of probe
300 frame
302 Frame top
303 Edges of frame
305 location of probe and clearance hole

FIG. 3B—probe, clearance hole, port
301 probe visible through clearance hole in Frame (detailed view of 305)
310 clearance hole in Frame
320 notch in filter
330 hole in electronics module

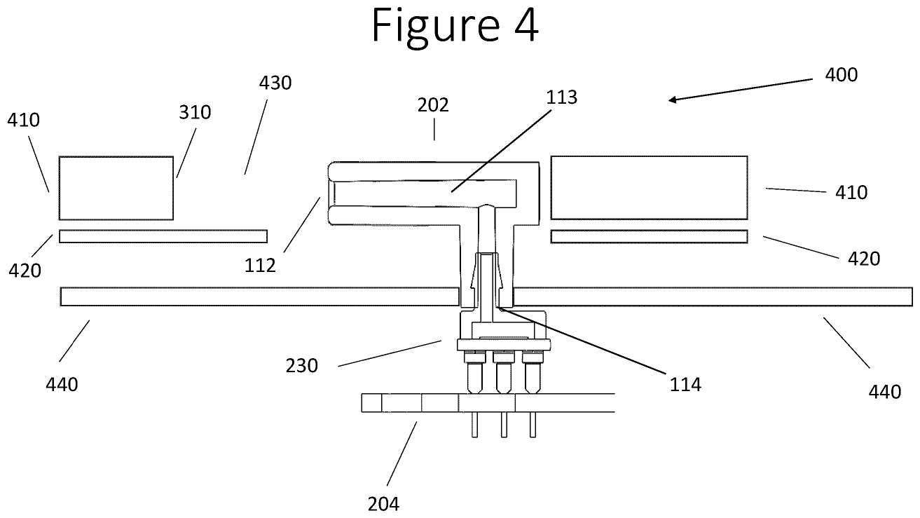

FIG. 4—alternate embodiments of clearance hole and probe
400 alternate embodiments of clearance hole and probe
410 top of filter frame
420 filter
430 air space
440 bottom of electronics module

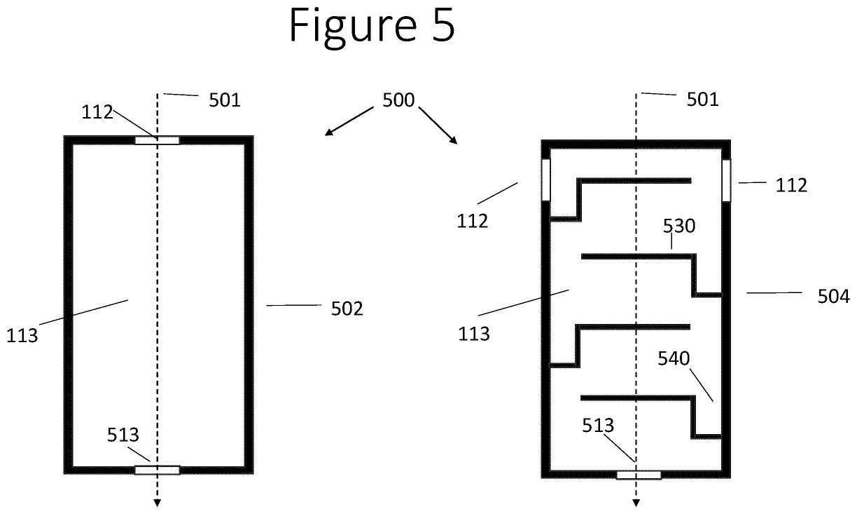

FIG. 5—serpentine path concept (absolute pressure sensors+)
500 serpentine path concept (absolute pressure sensors+)
501 direction of air flow
502 example of a simple manifold
504 example of a manifold illustrating serpentine path
513 hole in manifold
530 barrier
540 dust trap

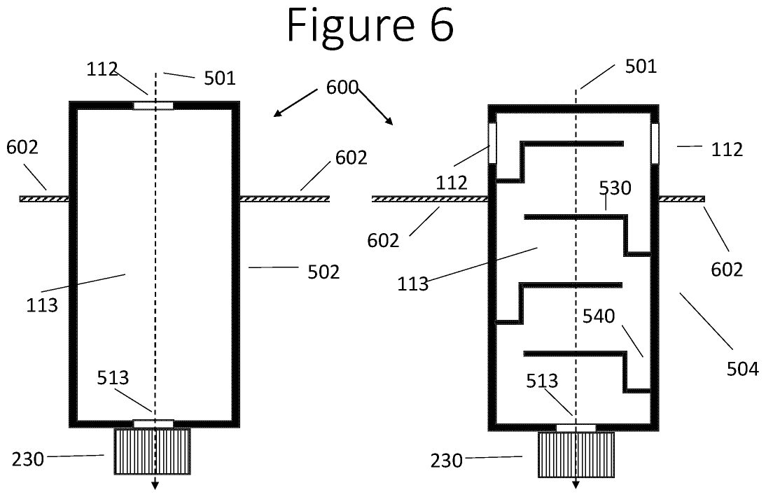

FIG. 6—serpentine path concept (differential pressure sensors)
600 Comparison of simple manifold 502 with counterpart 504 which illustrates a serpentine path
602 filter

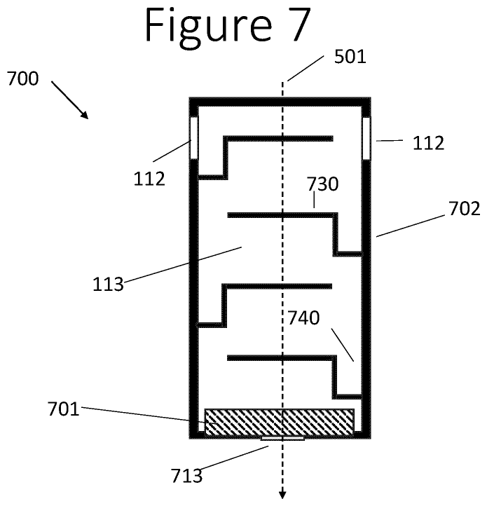

FIG. 7—sensor with housing incorporating serpentine path
700 sensor with housing incorporating serpentine path
701 sensor element
702 housing
713 port exposing bottom of element to external air
730 dust barrier
740 dust trap

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

FIG. 1 shows an embodiment of the present disclosure. The manifold 100 provides fluid communication between unfiltered air outside the filter frame, and a sensor located within the filter frame. Fluid communication is provided by means of a port (or plurality of ports) 112 linking the air column 113 within the manifold cavity to unfiltered air outside the frame, and by opening 114 leading from the cavity within the manifold to the sensor. In some embodiments, the probe 110, including the extremity of the manifold extending into the unfiltered air, has its tip sealed with a cap 116. A plurality of ports 112 are disposed on the probe walls establishing fluid communication between the unfiltered air outside the manifold and the air column within, allowing for the measurement of static air pressure. The cap 116 prevents a velocity component of the air from being measured. In this embodiment, the opening 120 is sealed by a plug 125. Alternatively, the opening 120 may be used for mounting the manifold within the electronics module. Particles of dust in the unfiltered air outside the probe 110 must pass around cap 116, through a port 112, travel along the air column in the manifold, and deflect by 90 degrees to eventually reach the sensor. The trajectories of dust particles arriving at the sensor follow a serpentine path, as will be further illustrated in FIGS. 5 and 6.

FIG. 2 shows an alternate embodiment 200 of the manifold 202 and related components. For this embodiment, the longer segment of the manifold 202 is the probe 110 which emerges into unfiltered air. The axis of the probe is substantially parallel to the top of the filter frame, with a single port 112 consisting of an unsealed opening at the tip of the probe. In this figure, a sensor 230 mounted on a printed circuit board 204 connect to opening 114 which in this embodiment is located at the end of the shorter manifold segment which is substantially perpendicular to the top of the filter frame (not shown here, see FIGS. 3 and 4).

In some embodiments, a differential pressure sensor is selected that does not require any flow of air through or past the sensor element. Such sensors are here described as Non Flow-Through Sensors (NFTS). In other embodiments, the differential pressure sensors require a stream of air to move across or past the sensor element: Flow-through Sensors or FTS.

FIG. 3A shows a typical filter frame 300, including the frame top 302 and the location 305 of the clearance hole in the frame top through which the probe emerges into the unfiltered air, which are shown in detail in the next figure. This location, away from the frame edges 303, is an important characteristic of this invention, contributing to improved accuracy and reproducibility of the sensor signal by minimizing airflow effects such as turbulence (among others) which tend to be more pronounced at the edges.

FIG. 3B shows the placement details 301 of the probe 110, clearance hole 310 as well as the notch 320 in the filter and hole 330 in the electronics module. Care is taken to seal the gap between the hole 330 in the electronics module and the probe 110 for more accurate measurements. A port 112 is visible on the wall of the probe, which in this case has an axis substantially perpendicular to the frame top. Note that in this drawing, unfiltered air comes from above and passes through the filter, driven by a pressure difference which is measured by the NFTS differential sensor employed in some embodiments.

Airflow effects such as, but not limited to turbulence can introduce inaccuracy into the measurements of a sensor such as, without loss of generality, a differential pressure sensor. Such effects can be reduced by providing air space between the probe ports and the inside edges of a suitably designed clearance hole in the frame top. Similarly, signal accuracy improves with the optimization of the size and location of ports that provide fluid communication between the unfiltered air outside the probe and the sensor within the electronics module and connected to the unfiltered air flow via the manifold. An additional variable in this embodiment of the invention is the extent to which the probe tip protrudes beyond the external surface of the frame top and into the airflow.

FIG. 4 shows an alternate embodiment 400 for the clearance hole 310 in the top 410 of the filter frame, which provides an air space 430 sampled by the port 112 in the alternate embodiment 202 for the manifold. In this alternate embodiment, the probe 110 is the longer section of the manifold 202. The axis of the air column 113, where it passes through the probe, is substantially parallel to the frame top 302. For further clarity, the filter 420 is shown below the filter top 302, as well as an exemplary sensor 230 mounted on a printed circuit board 204 and the shell 440 of the electronics module containing the sensor 230, protecting that space from unfiltered air.

This alternate embodiment allows only dust particles that follow a particular serpentine path to travel from the region outside the manifold, through inlet port 112, deflecting into a substantially perpendicular section of the internal cavity prior to reaching the sensor 230. The concept of a serpentine path is further illustrated in FIGS. 5 and 6.

FIG. 5 illustrates the serpentine path concept by means of a comparison 500 of two manifolds. Dashed arrow 501 indicates that the air flow in the diagram is substantially vertical and downward. On the left is an example of a simple manifold 502. On the right, structure 504 is an alternate embodiment of a manifold consistent with the invention disclosed in this application. Once again, dashed arrow 501 indicates that the air flow in the diagram is substantially vertical and downward. For the simple manifold 502, a dust particle entering through port 112 may follow a linear path through the air column 113 within the manifold to opening 513. The disclosed manifold 504 eliminates linear, direct trajectories as possible paths for dust particles to travel from ports 112 to the opening 513. This can be accomplished, as an example and without exclusion of other embodiments, by introducing one or more barriers 530 within the manifold, as well as optional dust traps 540. Disclosed manifold 504 is said to impose a serpentine path on dust particles if they are to move through the entire air column 113.

The lateral placement of ports 112 on disclosed manifold 504 is helpful if, for example, there is air flow moving in a direction that is vertical and downward in this figure. The lateral location makes it less likely that dust particles will enter the manifold than for simple design 502.

FIG. 6 further illustrates the serpentine path concept in manifold 504. Once again, dashed arrow 501 indicates that the air flow in the diagram is substantially vertical and downward. The simple manifold 502 is now shown along with filter 602 and sensor 230 in a comparison 600 with manifold 504. For the purposes of this discussion, sensor 230 is assumed, without loss of generality, to be a differential pressure sensor that requires no internal air flow (NFTS). Also note that in yet another embodiment, the sensor could reside within the manifold.

The air above filter 602 contains dust particles that are removed as the air flows downward in the drawing, through filter 602 and into the space below. The air flow is produced by the pressure difference across the filter. For the simple manifold 502, there are no obstacles preventing dust particles that enter through port 112 from passing through opening 513 and into sensor 230. In contrast, disclosed manifold 504 features laterally placed ports. Disclosed manifold 504 further includes internal elements such as barriers 530 and dust traps 540 that impose a serpentine path on any dust particles that attempt to travel through the substantially stationary air starting at port 112 and arriving at opening 513 (compare to 114) and pass into sensor 230. Once again, note that the sensor could reside inside of manifold 504 instead of being external. Dashed arrow 501 again indicates that the air flow in the diagram is substantially vertical and downward.

A person of ordinary skill in the art will realize that there are other ways of imposing a serpentine path on dust particles, including but not limited to tubing with one or more curves.

FIG. 7 represents a sensor 700 comprising a sensor element 701; a housing 702 protecting the sensor element from dust and debris, and providing a pressure tight chamber to allow for accurate pressure readings; features internal to the housing such as barriers 730 and dust traps 740 as well as one or more ports 112 sampling air on one side of the sensor element and port 713 on the opposite side. Sensor element 701, in some embodiments, is a transducer capable of generating an electric signal proportional to the difference in pressure across the sensor element. Sensor 700 thus incorporates the serpentine path inventive idea into a housing that is included in the sensor assembly by the manufacturer. For many applications, this would eliminate the need for a separate manifold such as 504 or 502. The shape of the housing and internal obstacles to dust particle diffusion can of course be adapted in ways that remain consistent with the disclosed invention.

A person of ordinary skill in the arts will further realize that although the sensor protected from dust and other contaminants in the preceding discussion is a differential pressure sensor, certain other sensors would similarly benefit from the reduced presence of dust on sensor surfaces. Similarly, such a person would recognize that other air filtration solutions in systems unrelated to HVAC could benefit from this invention. Improved sensor performance enabled by either or both benefits provided by this invention could be valuable in other settings. The benefits are reduced accumulation of dust and contaminants at a sensor, and reduction of signal inaccuracies due to airflow phenomena including but not limited to turbulence.

It is understood that although we repeatedly refer to “dust particles”, this is done to avoid cumbersome sentences and a person of ordinary skill in the art would recognize that “dust particles” can include aerosols and other droplets as well as a wide range of sub-millimeter objects including (without limitation) fibers from both textile and animal origin, fragments of insect or spider bodies, excreta produced by insects or spiders, etc.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. An air filter frame comprising:
a frame top;
a filter under the frame top;
a probe extending though the filter;
a sensor receiving air from the probe;
an orifice in the frame top, the probe being inserted in the orifice to protrude from the orifice, wherein a vented extremity of the probe emerges from the orifice, and wherein the orifice is sized to ensure an optimum lateral clearance between an inner edge of the orifice in the frame top and the protruding probe.

2. The air filter frame of claim 1, wherein the sensor is a pressure sensor.

3. The air filter frame of claim 2, wherein the optimum lateral clearance is selected to reduce inaccuracy in differential pressure sensor readings from the sensor.

4. The air filter frame of claim 1, wherein the probe includes side walls with ports and a capped airtight element sealing one end, wherein the sensor is positioned on the opposite end.

5. The air filter frame of claim 1, wherein the probe has a T-shape.

6. The air filter frame of claim 1, wherein the probe is located substantially away from the edge of the top frame facing unfiltered air.

7. The air filter frame of claim 6, further comprising an electronics module coupled to the sensor, wherein the probe allows the sensor to respond to conditions external to the electronics module and filter frame.

8. The air filter frame of claim 1, wherein the sensor senses differential pressure across the top frame and the filter, wherein the probe provides a conduit between a the filtered air side of the frame and an unfiltered air side of the frame, thereby allowing the differential pressure across the frame and filter to be measured by the sensor.

9. The air filter frame of claim 1, wherein the probe includes a housing configured with a serpentine path for dust particles traveling between the exterior of the probe to the sensor.

10. A manifold for directing air to a sensor in an air filter, the manifold comprising:
a set of side walls;
a vented probe extending from one of side walls;
ports in the side walls;
a capped, airtight element sealing one end of the probe, wherein an opposite end of the probe is positioned near the sensor.

11. The manifold of claim 10, wherein the probe reduces or eliminates dynamic pressure readings in the sensor.

12. The manifold of claim 10, wherein the ports comprise holes.

13. The manifold of claim 10, wherein the manifold has a T-shape.

14. A method of using a manifold in an air filter frame product, the method comprising:
connecting a pressure sensor located within an electronics module to one end of the manifold;
exposing an opposite end of the manifold to an exterior side of the air filter frame product where unfiltered air arrives; and
configuring the manifold to force dust particles attempting to travel from the exterior side of the product to the pressure sensor to follow a serpentine path.

15. The method of claim 14, wherein the manifold has a T-shape.
